(19) United States
(12) Patent Application Publication
(10) Pub. No.: US 2025/0102117 A1
(43) Pub. Date: Mar. 27, 2025

(54) ADAPTER AND MEASURING SYSTEM FOR A PRESSURE VESSEL

(71) Applicant: WIKA Alexander Wiegand SE & Co. KG, Klingenberg (DE)

(72) Inventors: Daniel FUCHS, Mosbach (DE); Andreas BROENNER, Johannesburg (DE)

(73) Assignee: WIKA Alexander Wiegand SE & Co. KG, Klingenberg (DE)

(21) Appl. No.: 18/896,195

(22) Filed: Sep. 25, 2024

(30) Foreign Application Priority Data
Sep. 26, 2023 (DE) 10 2023 126 126.6

(51) Int. Cl. F17C 13/02

(52) U.S. Cl. CPC F17C 13/02; F17C 2250/0417; F17C 2270/07

(57) ABSTRACT

An adapter for a pressure vessel comprising a first connection for coupling to a device for filling and/or withdrawing a fluid, in particular a gas, a second connection for a fluid-tight connection with the pressure vessel, and a line section. The line section extends along a longitudinal axis and connects the first connection with the second connection and thereby a gas-permeable connection between the first connection and the second connection exists or can be established via an interior space. At least one sensing unit s set up to detect at least one physical quantity and to convert it into at least one measurement signal. An evaluation unit is connected to the sensing unit and the evaluation unit is set up to process and/or evaluate the measurement signal and to make it available as an output signal via the communication interface.

This nonprovisional application claims priority under 35 U.S.C. § 119(a) to German Patent Application No. 10 2023 126 126.6, which was filed in Germany on Sep. 26, 2023, and which is herein incorporated by reference.

### BACKGROUND OF THE INVENTION

### Field of the Invention

The invention relates to an adapter for a pressure vessel, a measuring system and a further measuring system. The invention also relates to the use of an adapter, as well as a pressure vessel with an adapter. Furthermore, the invention relates to a soda maker.

### Description of the Background Art

Pressure vessels, gas cylinders and, in particular, CO2 gas cartridges for soda makers are known from the conventional art. In a conventional bubble process, any amount of CO2 can be transferred from the gas cartridge into the water at the touch of a button on the soda maker. However, there is no way to monitor when such a gas cartridge is empty or becomes empty or what percentage of the filling quantity is left.

### SUMMARY OF THE INVENTION

It is therefore an object of the invention to provide a cost-effective adapter or a measuring system which is connected to a pressure vessel, wherein a fill level, a residual pressure and/or a residual mass of the pressure vessel can be determined with the adapter or the measuring system. Furthermore, the object of the invention is to create a soda maker with a measuring system for determining the fill level of a connected pressure vessel.

In an example, an adapter for a pressure vessel according to the invention can comprise a first connection, for coupling to a device for filling and/or withdrawing a fluid (liquid filling/withdrawal device), in particular a gas. A second connection is also provided for the fluid-tight connection of the adapter to the pressure vessel. A line section extends along a longitudinal axis and connects the first connection with the second connection. A gas-permeable connection is formed between the first connection and the second connection via an inner space. This enables loss-free conduction of the fluid from the first connection to the second connection, and vice versa.

Furthermore, the adapter can include at least one sensing unit, which is set up to detect at least one physical quantity and convert it into at least one measurement signal. The physical quantity can be, for example, a pressure, a temperature or a fill level of the pressure vessel. Furthermore, it is possible, for example, to determine a length or strain on the basis of a measured resistance of a strain gauge, by laser, capacitively, inductively. Furthermore, it may also be provided to carry out a time measurement, for example how long a valve is open. The above technical principles do not stand alone, but can also be combined with each other, in particular to ensure a particularly high level of reliability and the failsafe operation of the adapter. The measurement signal is in particular an electrical measurement signal, for example a current.

Furthermore, the adapter can include an evaluation unit having a power supply unit and a communication interface. The evaluation unit is electrically connected to the sensing unit and is set up to process and/or evaluate the measurement signal from the sensing unit and to provide it as an output signal via the communication interface. The processing includes, for example, an analogue-to-digital conversion, while the evaluation goes one step further and includes the comparison of at least two measurement signals or measured values and provides a result.

The output signal can be provided both as an analog signal via a current loop, for example according to the 4-20 mA standard, as well as a digital signal via an industry-standard fieldbus system such as HART or PROFIBUS. The adapter and especially the evaluation unit (power supply unit) can be supplied with electrical energy via an integrated battery or, both, via the fieldbus system or the current loop. Multiple redundant systems that are independent of each other, especially multiple power supply units, can help increase resiliency.

The pressure vessel can be, for example, a gas cylinder, in particular a CO2 cylinder (CO2 gas cartridge). The device for filling and/or withdrawal can, for example, be a soda maker, which has a suitable receptacle for the first connection for the indirect coupling of CO2 gas cartridges via the adapter.

The adapter can be attached to pressure vessels as a mobile or permanent measuring device. This means that pressure and/or level measurement is also possible on pressure vessels that were previously equipped without a measuring device. Furthermore, intelligent evaluation can also be used to predict a remaining level.

The adapter can include at least one push rod, with the push rod essentially extending from the first connection to the second connection. Furthermore, the push rod can essentially be located in the interior. The push rod is designed to move from a resting position to an actuation position, and vice versa. For this purpose, the push rod is mounted either at the first connection or the second connection or at both connections in a movable manner. The push rod can also be movably mounted on the interior of the adapter. The movement, in particular displacement, of the push rod between the two positions mentioned can be parallel to the longitudinal axis or along the longitudinal axis.

The sensing unit can detect a change in the position of the push rod and/or a relative movement of the push rod with respect to the sensing unit. This can mean, for example, the displacement of the push rod along the longitudinal axis. The push rod is in motion while the adapter itself is at rest.

By designing the adapter with the push rod, a particularly simple and cost-effective construction of the adapter can be achieved.

The push rod can have a sealing contour at least in sections and forms a mechanical valve with the first connection or the second connection and/or the interior.

The push rod can be designed to close the mechanical valve in the resting position, so that the gas-permeable connection between the first and second connections is closed. The push rod can also be designed to open the mechanical valve in the actuation position, opening the gas-permeable connection between the first and second connections.

This makes it possible to also connect the adapter to pressure vessels that are equipped without a valve. The filling and withdrawal of gas from such pressure vessels can only be carried out via the adapter.

The adapter can be designed to be connected to a pressure vessel that has a self-closing valve. The push rod can be designed to enter into active contact with the self-closing valve of the pressure vessel in the actuating position so that it is opened. A length of the push rod along the longitudinal axis can be chosen large enough so that the self-closing valve can be operated. For example, the push rod is at least as long as the interior of the adapter. In the resting position, the push rod rests against the self-closing valve without any force. From the beginning of the actuating movement of the push rod until it reaches the actuating position, a force is applied to the self-closing valve and it is opened in the process. This configuration makes the adapter particularly flexible and suitable for a wide variety of pressure vessels.

The length of the line section can be variable along the longitudinal axis and that a distance between the first connection and the second connection is variable. This means, for example, that the length of the line section increases or decreases depending on the mass or pressure of the pressure vessel. Similarly, the distance between the first connection and the second connection also increases or decreases.

The adapter can comprise at least one elastic, wherein the elastic has at least a first end section and a second end section. The first end section is connected to the first connector and/or forms the first connector of the adapter. Further, the elastic on the second end section is connected to the second connection and/or forms the second connection of the adapter. The connection can be material-tight or force-fitted, for example. The above-mentioned line section can be, for example, a telescopic tube, a flexible hose or the elastic.

The sensing unit can be designed to detect at least a distance between the first connection and the second connection, either directly or indirectly. Direct sensing can be understood as the measurement of the distance between two components, for example the first connection and the second connection. Indirect sensing can be, for example, the measurement of a change in the length of the elastic itself. The elastic enables particularly precise level measurement at low fill levels or low pressures of the pressure vessel.

The elastic can be an elastic bellows and/or an elastic tension or compression spring. The elastic bellows can be compressed or stretched depending on the mass of the pressure vessel and/or the mass of the fluid and/or the pressure of the pressure vessel itself. For example, the length of the elastic bellows increases with increasing mass or pressure of the pressure vessel. In the opposite case, the mass and/or pressure of the pressure vessel can be reduced and the elastic bellows is compressed. An elastic compression spring can also be provided. For example, in combination with a flexible, elastic line section, for example a flexible hose, a similar effect can be achieved as with the elastic bellows. It may also be provided that an additional elastic compression spring is provided in addition to the elastic bellows. The elastic compression spring is provided to keep a characteristic curve of the elastic bellows as constant as possible. The elastic bellows, which are made of plastic, for example, lose elasticity over time and the measurement result would drift off or be falsified. The above-mentioned compression spring can counteract this, provided that it is arranged in the same direction of action as the elastic bellows.

The adapter can include a mechanical, electrical, electromagnetic or pneumatic valve, which is located at the first connection or at the second connection. The valve has the function of controlling the flow rate between the pressure vessel and the filling/withdrawal device. This design of the adapter is advantageous, for example, for pressure vessels that do not themselves have a permanently installed valve. This makes the adapter particularly versatile.

The combination of the valve with the elastic bellows yields two different measurement results. If the valve is located at the first connection between the elastic bellows and the filling/withdrawal device, the pressure of the pressure vessel has an influence on the strain or compression of the elastic bellows with an effect on the measurement result. However, if the valve is located at the second connection between the pressure vessel and the elastic bellows, the pressure of the pressure vessel has no influence on the compression or strain of the elastic bellows. The advantage of the latter design is that the pressure, which is temperature-dependent, does not have to be compensated in order to measure the mass of the pressure vessel and/or the fluid.

The elastic can be arranged concentrically around the push rod. For example, the push rod can have a valve body at one section, which forms a valve together with a section of the elastic bellows. When the push rod is actuated, the push rod is moved from the resting position to the actuation position and the valve is opened. For this function, a concentric arrangement of the push rod and elastic bellows is particularly advantageous.

A fuse assembly can be provided that is configured to limit deflection, in particular maximum strain and/or compression of the elastic. For example, the fuse assembly can be located at the first connection or the second connection. The fuse assembly has the advantage of protecting the adapter and especially the elastic from overload or limiting an acting load. A guide assembly may also be provided, which is configured to restrict movement of the elastic to an essentially translational movement of the elastic along a symmetry axis of the elastic. For example, the guide assembly can be fixed between the first connection and the second connection. Furthermore, it may be provided that the guide assembly is arranged externally around the elastic and/or in the interior to produce a guide for the elastic. The guide assembly helps to ensure to limit the movement of the elastic to largely one direction. This can improve the accuracy of the measurement.

The fuse assembly and/or the guide assembly can be arranged within the elastic and/or the fuse and guide assembly can be combined in a common assembly. For example, this common (combination) assembly may be an end-stop sleeve. The elastic is passed through the sleeve and prevented from further movement, for example further excessive, irreversible strain, by the end stop. The common assembly can also make the adapter easier and more cost-effective to manufacture and maintain.

The sensing unit can include at least one Hall sensor and that this can be located at least at the first and/or second connection of the adapter and/or at the interior.

Furthermore, the elastic and/or the push rod can have at least one magnet, wherein the magnet can be arranged at least in a sensing area of the Hall sensor of the sensing unit, wherein a relative movement of the magnet with respect to the Hall sensor can be detected with the Hall sensor. The relative movement is made possible by the fact that the Hall sensor is fixed in the adapter, not movable. On the other hand, the magnet can perform a translational movement via the elastic and/or the push rod, after which it moves relative to or in relation to the Hall sensor.

Depending on the requirements for measurement accuracy, different combinations of the above-mentioned features are possible. For example, it may be provided to measure only the number or frequency of push rod actuations and their duration of operation. For this purpose, a magnetic effect of the push rod by means of a magnet is provided, at least in sections. For example, a Hall sensor or a reed contact can be located in the area of influence of the magnetic field of the magnet at a corresponding location in the interior and/or at the connections of the adapter.

Further, the adapter can have an elastic bellows and a push rod. A magnet can be arranged on both the elastic bellows and the push rod. In the area of influence of the respective magnetic field, at least one Hall sensor can be arranged, which detects the relative movement of the magnet with respect to the sensor. In this case, the level of a pressure vessel connected to this adapter can be determined using two complementary and at the same time redundant measurement methods. The number of push rod actuations can be used to calculate an extrapolation of remaining actuations. The number can be compared with the strain or compression of the elastic bellows determined at the same time and the result can be corrected or verified. This enables particularly accurate and reliable level measurement.

The communication interface of the evaluation unit can include a wireless module that is designed to transmit measured values wirelessly to a cloud and/or to a mobile device using at least one wireless protocol. A wireless protocol can be, for example, WirelessHART, Bluetooth or LoRaWAN. Wireless data transmission makes it possible to measure, evaluate and reproduce the measurement results regardless of location. This can also be associated with automatic reordering services and subscriptions. For example, when a pressure vessel is running low, a new, filled pressure vessel can be automatically ordered via a cloud-based service. This is then delivered in time before the pressure vessel that is currently in use is completely emptied. This avoids long waiting times and makes delivery logistics more efficient and customer-oriented.

The sensing unit can include at least one optical sensing system, in particular a radar or lidar-based sensing system for non-contact distance measurement between the first connection and the second connection. One of the two connectors can be provided as a reflector, which directs an emitted light beam to a sensor, such as a photodiode.

Furthermore, it may also be provided that the optical sensing system can be located between the sensing unit and the push rod. For example, the push rod can be positioned between a light source and a sensor. The push rod interrupts the light beam with each actuation, which is detected by the sensor. This way, the actuation time can be measured particularly precisely.

A measuring system can include an adapter with an elastic bellows and/or a push rod. The adapter can be connected to a pressure vessel, wherein the pressure vessel can be filled with at least one fluid, such as carbon dioxide (CO2). Furthermore, the adapter can be connected to a filling or withdrawal device. This device can be, for example, a soda maker. A sensing unit of the adapter detects an actuation time and/or an actuation frequency of the push rod and forms a measured value from it. The sensing unit detects a strain or compression of the elastic bellows and forms a measured value from it.

The evaluation unit can be set up to calculate either a pressure and/or a fill level of the pressure vessel on the basis of the measured values. The evaluation unit can also be set up to send the measured values to a mobile device and/or a cloud. The measured values are stored on the mobile device and/or in the cloud and a pressure and/or level of the pressure vessel is calculated from them.

The measuring system is particularly flexible in its application due to the use of measuring principles by means of elastic bellows and/or the push rod. Depending on the size or weight of the vessel, the level of the pressure vessel is calculated either by the deformation of the elastic bellows or by the number of push rod actuations. A particularly high level of measurement accuracy can be achieved by using the elastic bellows and the push rod at the same time, as the level can be calculated independently of both systems, thereby reducing possible errors. Furthermore, by connecting the adapter to the mobile device or the cloud, measurements of the pressure and/or level can be carried out not only on site, but also remotely. A stay of qualified personnel in potentially dangerous environments or cost-intensive maintenance times can thus be effectively reduced.

The remaining service life of the pressure vessel can be extrapolated from the time curve of the measured values. The evaluation unit, the mobile device and/or the cloud calculate and store the usage behavior of the adapter, which is obtained from the measured values. For example, the usage behavior can depend on the season, time of day, or day of the week. The stored measured values can thus be used to indicate an increasingly accurate usage behavior over time. Furthermore, when a programmable threshold value is reached, a reordering service for a new, fully filled pressure vessel can be triggered.

Furthermore, certain pressure vessel sizes and gas quantities can be stored in a memory of the adapter. For example, the pressure vessel size can be entered via an RFID chip or via manual teach-in via the mobile device. This makes it possible to estimate a rough remaining useful life for the first use. However, this becomes more accurate with progressive use. With at least one complete run-through of a pressure vessel, i.e., from full to empty, the number of push rod actuations (pressure surges) required to completely empty the pressure vessel is stored for the respective cylinder size. This maximum number is set for the next, new pressure vessel and a counter counts down the remaining push rod actuations. In addition, the level can be displayed on the soda maker, on the mobile device and/or in the cloud.

The adapter can also be used to measure the level of pressure vessels in soda makers. In particular, advantage and effects of the adapter are also provided when using the adapter for level measurement in pressure vessels for soda makers, unless stated otherwise.

A pressure vessel can include the adapter. In particular, advantages and effects of the adapter are also provided for a pressure vessel with an adapter.

A further measuring system according to the invention can be a soda maker for measuring a fill level of a pressure vessel connected to the soda maker. The soda maker can comprise a button, wherein a valve on the pressure vessel and a measurement signal can be triggered directly or indirectly by pressing the button. A central control system is connected and/or coupled to the button in such a way that the remaining fill level of the pressure vessel can be estimated by means of detecting and evaluating the measurement signal, the number of button presses and/or the duration for which the button is pressed. By evaluating the button presses, a particularly cost-effective and simple solution for estimating the remaining fill level of the pressure vessel is possible. Another advantage is that the measuring system can be easily integrated into the housing of the soda maker.

The button can be an electric button or includes an electric button. By pressing the button, an electrical contact of the electric button is closed. The central control system detects and processes the number or frequency of button presses and/or the duration for which the button is pressed and displays the remaining fill level on a display unit of the soda maker and/or on a mobile device. The electric button can also be a microswitch, for example, which is particularly easy to install in the soda maker due to its compact dimensions and can be connected to the button or mechanically coupled.

The remaining service life of the pressure vessel can be extrapolated from the time curve of the number of button presses and/or the duration for which the button is pressed. The central control system, the mobile device and/or a cloud calculates and stores the usage behavior of the soda maker. When a programmable threshold value is reached, a reordering service for a fully filled pressure vessel can be automatically triggered. This can effectively reduce the waiting times that previously occurred until a new, filled pressure vessel arrives.

A soda maker according to an example of the invention comprises a measuring system with an elastic bellows and/or a push rod. The soda maker can also have a measuring system with the previously described versions of a button. For example, an adapter with an elastic bellows and/or a push rod may be provided to detect the remaining fill level of the pressure vessel. A soda maker can have an integrated measuring system. In this case, the duration and frequency for which a button is pressed are used to determine the remaining fill level of a connected pressure vessel. On the one hand, the button thus fulfils the function of opening a valve on the pressure vessel and releasing gas. On the other hand, as just described, the button can also be used to determine the usage behavior (operating time, frequency). Together with an intelligent evaluation of this data, automatic reordering processes for new, full pressure vessels can also be triggered. This can trigger a timely reordering process and ensure an uninterrupted supply of pressure vessels/CO2 cylinders for soda makers.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a schematically shows an example of the adapter with an elastic bellows,

FIG. 1b schematically shows an example of the adapter with an elastic bellows,

FIG. 1c schematically shows an example of the adapter with an elastic bellows,

FIG. 2a schematically shows an example of the adapter with a push rod,

FIG. 2b schematically shows an example of the adapter with a push rod,

FIG. 3 schematically shows a soda maker, an adapter, a pressure vessel and a water bottle, and

FIG. 4 schematically shows a soda maker, as well as a combined valve for extracting gas from a pressure vessel and a water bottle to be filled.

### DETAILED DESCRIPTION

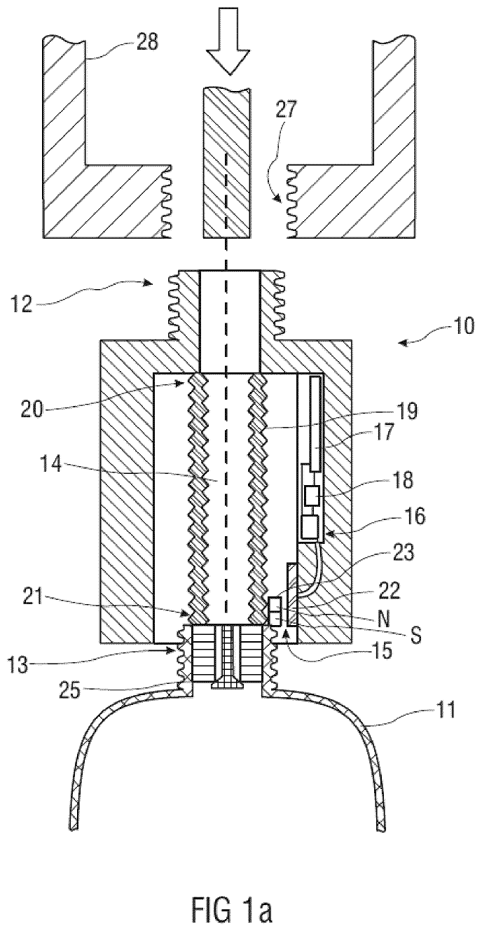

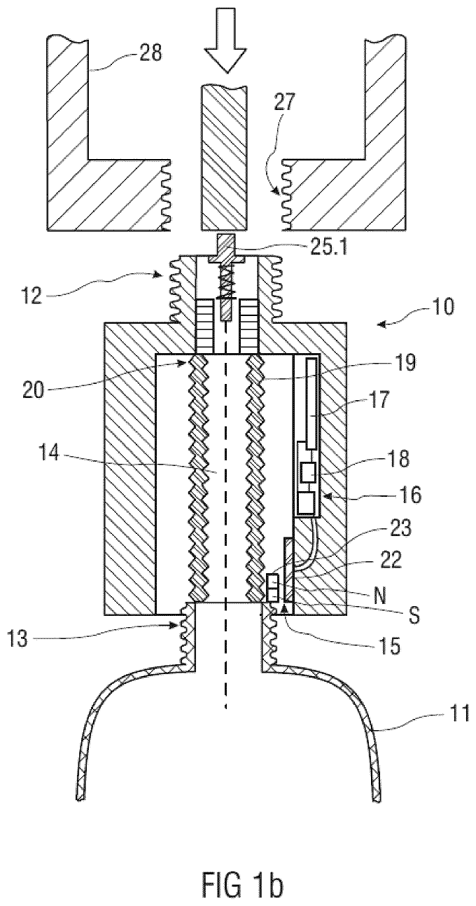

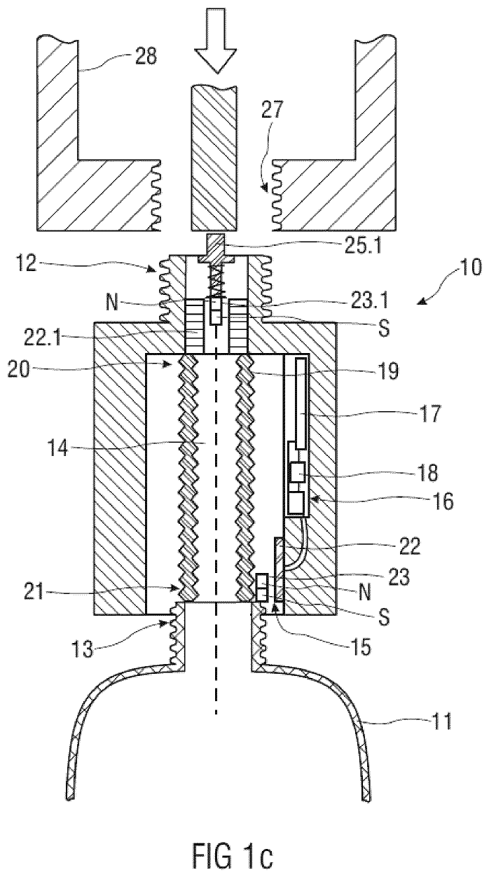

FIG. 1a schematically shows an example of an adapter 10. The adapter 10 is connected, for example screwed, via a first connection 12 to a connection 27 of a soda maker 28. Furthermore, the adapter 10 is connected to a pressure vessel 11 via a second connection 13. This connection can be, for example, a weld or a screw connection. Between the first and the second connection 12, 13 an elastic bellows 19 is formed. The elastic bellows 19 is connected to the first connection 12 of the adapter 10 at its first end section 20. Furthermore, the elastic bellows 19 is connected to a second end section 21 to the pressure vessel 11, in particular to a pressure vessel connection. In particular, a weld between the second end section 21 and the pressure vessel connection is also provided at this location.

The two connections between the elastic bellows 19 and the two connections 12, 13 of the adapter 10 are designed to be pressure-tight. Due to the pressure-tight design, a pressure- or fluid-tight space 14 is formed inside the elastic bellows 19. This allows for a fluid, in particular a gas, to pass from the pressure vessel 11 to the soda maker 28 without loss.

A sensing unit 15 comprises at least one Hall sensor 22, which is arranged inside the adapter 10. A magnet 23 is firmly connected to the elastic bellows 19. In particular, it is provided that at least some of the time the Hall sensor 22 is arranged in a sphere of influence of the magnet 23. In the event of a movement, in particular when the elastic bellows 19 is stretched, the magnet 23 moves with the elastic bellows 19. Depending on the mass of the pressure vessel 11 and the corresponding preload of the elastic bellows 19, a magnetic field of the magnet 23 reaches either inside or outside a sensing range of the Hall sensor 22. The sensing unit converts a resulting voltage potential into a measurement signal and passes it on to an evaluation unit 16.

The evaluation unit 16 is set up to evaluate and process the measurement signal and output it as an output signal via a communication interface 18. The adapter 10 is supplied with energy via a permanently installed energy supply unit 17, for example a rechargeable battery. In principle, however, a wired power supply can also be provided.

Gas-filled pressure vessels 11 usually also have a valve at the pressure vessel connection, which is schematically represented in the form of a pin valve 25. When the button is pressed, the pin valve 25 of the pressure bottle is pressed downwards (in the direction of the arrow) via a pin starting from the soda maker 28 (only schematically indicated). This allows for gas from the pressure vessel 11 to reach the soda maker 28 through the elastic bellows 19 and the connections 12, 13 of the adapter 10. With each press of a button, a certain amount of gas thus escapes from the pressure vessel 11, depending on how long the button is pressed. The press of the button and the associated escape of gas reduces the mass of the gas in the pressure vessel 11. This reduces the strain of the elastic bellows 19. The movement of the elastic bellows 19 is detected by the movement of the magnet 23 relative to the Hall sensor 22.

In this example of the arrangement of a valve 25 on the pressure vessel 11, but in front of the elastic bellows 19, the elastic bellows 19 is only loaded by the mass of the gas in the pressure vessel 11 and the constant mass of the pressure vessel 11 itself.

In contrast to FIG. 1a, FIG. 1b has a valve 25.1 located at or in the first connection 12 of the adapter 10. A separate valve on the pressure vessel 11 is missing. Thus, in addition to the mass of the gas and the pressure vessel 11, the elastic bellows 19 is also loaded by the pressure of the pressure vessel 11. A change in the pressure in the pressure vessel 11 has a corresponding effect on the strain or compression of the elastic bellows 19. For example, the valve 25.1 is opened in the direction of the arrow when operated and gas from the pressure vessel 11 enters a bottle, not shown, via the soda maker. With the escape of the gas itself, in addition to the mass of the gas, the pressure in the pressure vessel 11 also decreases to a certain extent. This effect of the pressure change occurs particularly clearly at low fill levels, shortly before the pressure vessel is completely emptied. In contrast, with a completely filled pressure vessel 11 with a pressure of about 16 bar, the pressure when the soda maker 28 is operated remains almost constant over a longer period of time.

In FIG. 1c, a valve 25.1 is arranged at the first connection 12 of the adapter 10. In addition to the evaluation of the extension or compression of the elastic bellows 19 via the sensing unit 15, an evaluation of the movement of the valve 25.1 is provided at the first connection 12. For this purpose, a magnet 23.1 is arranged on the valve 25.1. In or at the connection 12, but at least in the area of influence of the magnet 23.1, a Hall sensor 22.1 is arranged. The Hall sensor 22.1 detects every movement of the valve 25.1.

For example, it may be provided that a residual mass of the gas in the pressure vessel 11 can be determined and extrapolated by means of how frequent and how long the valve 25.1 is operated. This method is suitable for particularly high levels and high pressure. In order to verify the calculation and in addition to the above-mentioned method, a further measurement of the strain or compression of the elastic bellows 19 may be provided. This measurement can be advantageous, for example, at low pressures and lower levels.

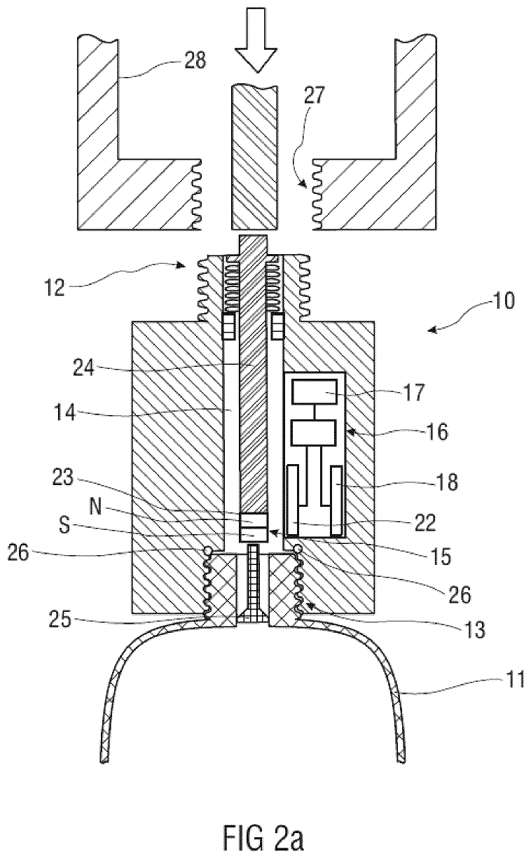

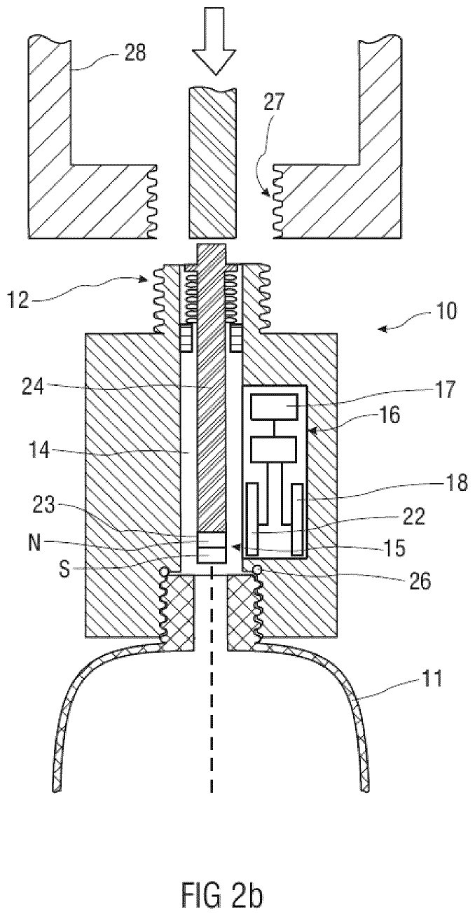

FIG. 2a shows an example of the adapter 10. The pressure vessel 11 has a schematically indicated pin valve 25. The first connection 12 of the adapter 10 is connected to the connection 27 of the soda maker 28. With the second connection 13, the adapter 10 is directly connected to the pressure vessel 11. There is no elastic bellows as shown in FIGS. 1 a-c. For example, the second connection 13 can be designed as a screw connection to match the connection thread of the pressure vessel 11.

Inside the adapter 10 is a push rod 24. In the upper area (at the first connection 12), the push rod 24 forms a valve section, in particular a valve, at least in some areas. For this purpose, a spring mechanism is provided that keeps the valve in a closed, sealing position without external influence. A magnet 23 is arranged at a lower area of the push rod 24, which is located within the coverage area of the sensing unit 15.

The functional principle of the example shown in this figure (FIG. 2a) is as follows. The push rod 24 is operated by pressing a button of the soda maker 28 in the direction of the arrow. The push rod 24 simultaneously presses on the pin valve 25 of the pressure vessel 11 and gas is released, which reaches the soda maker 28 via the adapter 10. The magnet 23 located at the lower end of the push rod 24 moves with each actuation of the push rod 23. Each individual actuation can thus be detected via the sensing unit 15, in particular the Hall sensor 22. In the evaluation unit 16, a residual mass of the gas in the pressure vessel 11 will be calculated or extrapolated using the number and duration of the push rod actuations. The output signal can be output via the communication interface 18. It may also be conceivable that the output signal is output via an unspecified wireless module of the evaluation unit 16.

FIG. 2b shows a variant of the example from FIG. 2a. This example is particularly suitable for pressure vessels without their own valve. On the adapter 11 a valve is provided via a sealing section of the push rod 24 in conjunction with the first connection 12. The adapter 10 is screwed to the pressure vessel 11 at the second connection 13. An O-ring 26 is located in the connection 13 of the adapter 10 to seal this connection. The residual mass of the gas is calculated by the number and duration of the push rod actuations.

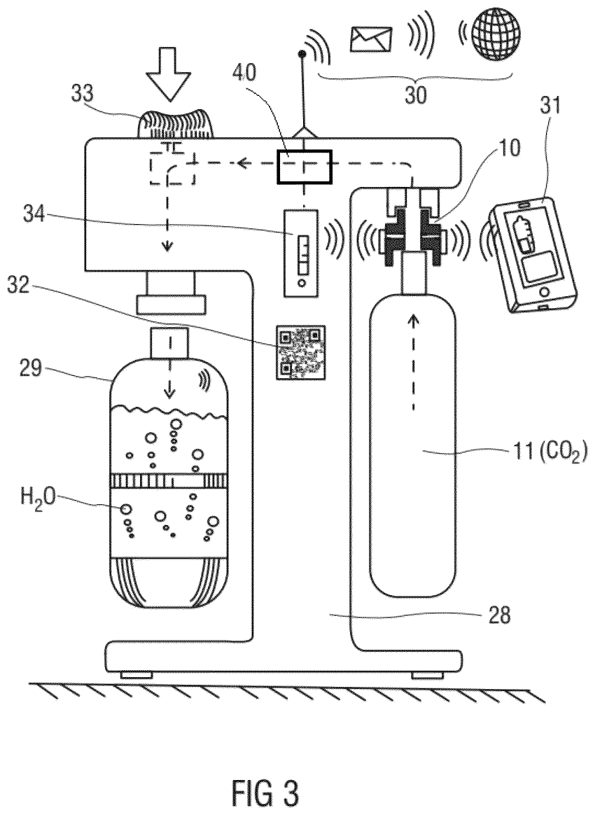

FIG. 3 schematically shows another possible application of an adapter 10 in conjunction with a soda maker 28. A pressure vessel 11 is connected to the soda maker 28 via the adapter 10. A water bottle 29 is pressure-tight connected to the soda maker 28. By pressing a button 33 that can be triggered manually, a valve on the adapter 10 and/or the pressure vessel 11 is opened via an unspecified mechanism of the soda maker 28. Gas, in particular CO2, then passes from the pressure vessel 11 via the adapter 10 and the soda maker 28 into the water bottle 29. With each push of a button, the mass of the gas in the pressure vessel 11 decreases. The current mass and/or the residual mass of the gas in the pressure vessel 11 is determined using the adapter 10. On the one hand, the mass/residual mass can be measured by measuring the strain or compression of a bellows of the adapter 10 that is not shown. Further, the button presses can be counted via the button 33 and/or a mechanism not further shown in FIG. 3, in particular of a push rod of the adapter 10. The requirement for level measurement by pressing a button or push rod is the amount of a fully filled pressure vessel. When replacing a pressure vessel 11, for example, a residual button that is not shown is pressed and a central control system 40 is reset. With each push of a button 33, the amount of gas in the pressure vessel 11 is reduced and the central control system 40 virtually counts down the remaining level. By storing the counted button presses, the usage behavior can be derived and the prediction of the remaining level becomes more accurate with each cycle.

With a smartphone 31, a connection to the Internet, especially cloud-based services 30, can be established via a QR code 32, which is located on the soda maker 28. In particular, a wireless interface may be provided on the adapter 10 or on the soda maker 28 for the wireless transmission of measured values. A wireless interface on the adapter 10 is particularly advantageous. The adapter 10 sends the measured values to the soda maker 28, to a mobile device or directly to the cloud 30, for example. The graphical output of the measured value can be done either directly on the smartphone 31 or on the soda maker 28. The soda maker 28 has a level indicator 34 for this purpose. The measured values can be stored and processed on the smartphone 31 and/or in the cloud 30. In particular, it is also provided that in the event that the level of the pressure vessel 11 is low, if a threshold value is exceeded, a new, fully filled CO2 pressure vessel 10 is automatically ordered from a service provider (gas cylinder supplier). This can effectively reduce the time until a new pressure vessel 10 arrives.

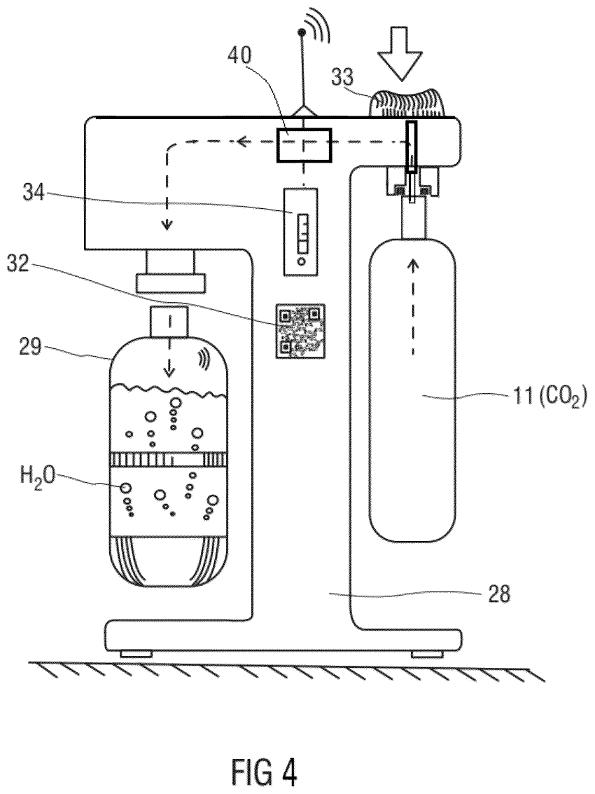

FIG. 4 schematically shows another possible design of a soda maker. The button 33 is located directly above the pressure vessel 11. The valve of the pressure vessel 11 can be opened via the button 33 and a schematically indicated push rod of the button 33. Here, the gas (CO2) flows from the pressure vessel 11 via the soda maker 28 into the water bottle 29. The flow path of the gas is schematically indicated by the dotted line. In the central control system 40, the number/frequency and duration of the button presses 33 can be recorded and processed. For example, the button 33 is mechanically connected to an electrical contact or to a microswitch. With each press of a button, the electrical contact is interrupted and closed again. These contact interruptions are detected by the central control system, evaluated and displayed as a remaining fill level. This can be indicated via the integrated display 34, for example. Wireless data transmission to a mobile device 31 or the Internet with a cloud 30, as shown in FIG. 3, may also be provided.

Furthermore, the pressure vessel can also be equipped with an RFID or other wirelessly readable indicator, which the control system uses to recognize the type of container, volume, filling and pressure.

Furthermore, a flow rate measurement of the amount of gas in the soda maker can be provided. For example, the flow rate can be measured according to the differential pressure principle by using a Venturi tube or a measuring orifice, or according to a thermal principle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An adapter for a pressure vessel, the adapter comprising:
a first connection to couple to a device for filling and/or withdrawing a fluid or a gas;
a second connection for creating a fluid-tight connection with the pressure vessel;
a line section that extends along a longitudinal axis and connects the first connection with the second connection, a gas-permeable connection between the first connection and the second connection existing or being adapted to be established in an interior space;
at least one sensing unit configured to detect at least one physical quantity and convert the at least one physical quantity into at least one measurement signal; and
an evaluation unit comprising an energy supply unit and a communication interface, the evaluation unit being connectable to the sensing unit, the evaluation unit being set up to process and/or evaluate the measurement signal and to provide an evaluated or processed measurement signal available as an output signal via the communication interface.

2. The adapter according to claim 1, further comprising:
at least one push rod that extends substantially from the first connection to the second connection,
wherein the push rod is essentially arranged in the interior space,
wherein the push rod is movably mounted at the first connection and/or the second connection and/or in the interior space of the adapter between a resting position and an actuation position, and
wherein the sensing unit detects a change in the position of the push rod and/or a relative movement of the push rod with respect to the sensing unit.

3. The adapter according to claim 2, wherein the push rod has a sealing contour at least in sections and thereby forms a mechanical valve with the first connection or the second connection and/or the interior space, wherein the push rod is configured to close the mechanical valve in a resting position so that the gas-permeable connection between the first connection and the second connection is closed, and wherein the push rod is designed to open the mechanical valve in an actuation position so that the gas-permeable connection between the first connection and the second connection is opened.

4. The adapter according to claim 2, wherein the adapter is connectable to a pressure vessel having a self-closing valve, and wherein the push rod is configured to enter into active contact with the self-closing valve of the pressure vessel in the actuation position so that it is opened.

5. The adapter according to claim 1, wherein a length of the line section along the longitudinal axis is variable, wherein a distance between the first connection and the second connection is variable, wherein the adapter comprises at least one elastic, wherein the elastic has at least one first end section and one second end section, the first end section is connected to the first connection and/or forms the first connection, wherein the elastic at the second end section is connected to the second connection and/or forms the second connection, and wherein the sensing unit is designed to directly or indirectly detect at least one distance between the first connection and the second connection.

6. The adapter according to claim 5, wherein the elastic is an elastic bellows and/or an elastic tension or compression spring.

7. The adapter according to claim 5, further comprising a mechanical, electrical, electromagnetic or pneumatic valve which is arranged at the first connection or at the second connection.

8. The adapter according to claim 5, wherein the elastic is arranged concentrically around the push rod.

9. The adapter according to claim 5, further comprising:
a fuse assembly which is designed to limit a deflection or a maximum strain and/or a maximum compression of the elastic; and/or
a guide assembly which is configured to restrict a movement of the elastic to an essentially translational movement of the elastic along a symmetry axis of the elastic.

10. The adapter according to claim 9, wherein the fuse assembly and/or the guide assembly are arranged within the elastic and/or wherein the fuse and guide assembly are combined in a common assembly.

11. The adapter according to claim 1, wherein the sensing unit comprises at least one Hall sensor and is arranged at least at the first and/or the second connection of the adapter and/or at the interior space, wherein the elastic and/or the push rod has at least one magnet, wherein the magnet is arranged at least in one sensing area of the Hall sensor of the sensing unit, and wherein a relative movement of the magnet with respect to the Hall sensor is detected with the Hall sensor.

12. The adapter according to claim 1, wherein the communication interface of the evaluation unit comprises a wireless module which is designed to transmit measured values wirelessly to a cloud and/or to a mobile device by at least one wireless protocol.

13. The adapter according to claim 2, wherein the sensing unit comprises at least one optical sensing system or a radar or lidar-based sensing system for non-contact distance measurement between the first connection and the second connection.

14. A measuring system comprising the adapter according to claim 1 and having an elastic bellows and/or a push rod, wherein the adapter is connected to a pressure vessel, wherein the pressure vessel is filled with at least one fluid, wherein the adapter is connectable with a filling or withdrawal device or a soda maker, wherein a sensing unit of the adapter detects the actuation duration and/or the actuation frequency of the push rod and forms a measured value therefrom, and/or the sensing unit detects a strain or compression of the elastic bellows and forms a measured value from it, and wherein the evaluation unit is set up either to calculate a pressure and/or a level of the pressure vessel on the basis of the measured values or the measured values are sent to a mobile device and/or a cloud and are stored there and a pressure and/or level is calculated from them.

15. The measuring system according to claim 14, wherein a remaining useful life of the pressure vessel is extrapolated from a time curve of the measured values, wherein the evaluation unit, the mobile device and/or the cloud calculates and stores the usage behavior of the adapter from the measured values, and wherein a reordering service for a fully filled pressure vessel is automatically triggered when a programmable threshold value is reached.

16. The adapter according to claim 1, wherein the adapter measures a level of pressure vessels in a soda maker.

17. A pressure vessel comprising the adapter according to claim 1.

18. A measuring system for a soda maker to measure a level of a pressure vessel connected to the soda maker, the soda maker comprising a button, wherein a valve on the pressure vessel and a measurement signal are adapted be triggered directly or indirectly by pressing the button, and wherein a central control system is connected and/or coupled with the button such that by detecting and evaluating the measurement signal, a number of times the button is pressed and/or how long the button is pressed is used to estimate a remaining fill level of the pressure vessel.

19. The measuring system according to claim 18, wherein the button is an electric button or comprises an electric button, wherein an electrical contact of the electric button is closed when the button is pressed and a number of button presses and/or a duration for which the button is pressed is detected and processed in the central control system and is displayed as a remaining level on a display unit of the soda maker and/or on a mobile device.

20. The measuring system according to claim 18, wherein the remaining service life of the pressure vessel is extrapolated from a time curve of the number of button presses and/or a duration for which the button is pressed, wherein the central control system, the mobile device and/or a cloud calculates and stores the usage behavior of the soda maker, and wherein automatically upon reaching a programmable threshold value a reordering service for a fully filled pressure vessel is triggered.

21. A soda maker comprising a measuring system according to claim 14.
